(19) United States
(12) Patent Application Publication
(10) Pub. No.: US 2019/0321151 A1
(43) Pub. Date: Oct. 24, 2019

(54) DENTAL PROPHY ORBITER

(71) Applicant: Microcopy Ltd., Afula (IL)

(72) Inventors: Philip Rader, Hixson, TN (US); Hannah Maxine Brink, Hilton Head, SC (US); Sydney Allison Fain, Christiansburg, VA (US); Jerrell Wenyao Fang, Johns Creek, GA (US); Abhijit Mukund Ravindran, Princeton, NJ (US); Emily Brayman, Atlanta, GA (US)

(21) Appl. No.: 16/393,511

(22) Filed: Apr. 24, 2019

Related U.S. Application Data
(60) Provisional application No. 62/662,035, filed on Apr. 24, 2018.

(51) Int. Cl. A61C 17/00; A61C 17/22

(52) U.S. Cl. CPC A61C 17/005; A61C 17/24; A61C 17/222

(57) ABSTRACT

A dental prophy orbiter is provided which includes a main housing having a shaft channel which receives a drive shaft configured to be coupled to a conventional dental rotating hand piece or to an angled portion which in turn is coupled to a hand piece. The main housing also includes a top surface with an centrally offset rod channel. The prophy orbiter also includes a polishing head coupled to the main housing for free, spinning rotational movement relative to the main housing. The polishing head includes a mounting rod configured to be rotationally received within the rod channel. The drive shaft is aligned along a longitudinal axis while the mounting rod is centrally offset, or axially or radially offset, from the drive shaft and the longitudinal axis along the drive shaft. A foam prophy pad is coupled to the mounting plate.

### REFERENCE TO RELATED APPLICATION

Applicant claims the benefit of U.S. Provisional Patent Application Ser. No. 62/662,035 filed Apr. 24, 2018 and entitled Dental Prophy Orbiter.

### TECHNICAL FIELD

This invention relates generally to dental polishing devices, and particularly disposable prophy angles for polishing teeth.

### BACKGROUND OF THE INVENTION

Dentist have used a rotating cup filled with a dental polishing compound or prophylaxis (prophy) paste to polish teeth. The prophy cup of the prophy angle is filled with prophy material and spun at a very high rate when applying the prophy material to the surface of the teeth.

A common problem with such prophy angles is that the prophy material is spun out of the confines of the cup, causing the prophy material to splatter about the adjacent area. This splattering creates a contamination issue to the hygienist and surrounding areas.

Another problem with such prophy angles is that the prophy material is somewhat gritty. This gritty material being applied to the tooth surface can cause scratching and wear of the tooth's enamel, filling material or outer surface or restorative materials. This scratching is increased due to the high speed and small surface area of the prophy angle or cup. The high speed in the same rotatory path also causes the build up of heat, resulting in sensitivity in the teeth.

Accordingly, it is seen that a need remains for a dental polishing device which does not cause splattering of the prophy material or scratching of the teeth. It is to the provision of such that the present invention is primarily directed.

### SUMMARY OF THE INVENTION

A dental prophy orbiter comprises a drive shaft, a main housing coupled to the drive shaft, a prophy head, and a mounting rod. The mounting rod has a first end and a second end, the mounting rod first end being coupled to the main housing in a centrally offset position, and the mounting rod second end being coupled to the prophy head. The rod is pivotally coupled to either the main housing or the prophy head. With this construction, the rotational movement of the drive shaft causes rotational movement of the main housing which results in orbital movement of the prophy head.

### BRIEF DESCRIPTION OF THE DRAWING

FIG. 1 is a perspective view of a prophy orbiter in a preferred form of the invention.

FIG. 2 is a cross-sectional view of the prophy orbiter of FIG. 1.

FIG. 3 is a side view of a prophy angle in the preferred form of the invention.

FIG. 4 is a perspective view of the polishing head of a prophy orbiter in another preferred form of the invention.

FIG. 5 is a perspective view of the polishing head of a prophy orbiter in another preferred form of the invention.

FIG. 6 is a perspective view of the polishing head of a prophy orbiter in another preferred form of the invention.

FIG. 7 is a perspective view of the polishing head of a prophy orbiter in another preferred form of the invention.

FIG. 8 is a perspective view of a polishing head and splatter shield of a prophy orbiter in another preferred form of the invention.

FIG. 9 is a perspective view of a polishing head and ring of a prophy orbiter in another preferred form of the invention.

FIG. 10 is a perspective view of a prophy orbiter in another preferred form of the invention.

FIG. 11 is a perspective view of a prophy orbiter in another preferred form of the invention.

### DETAILED DESCRIPTION

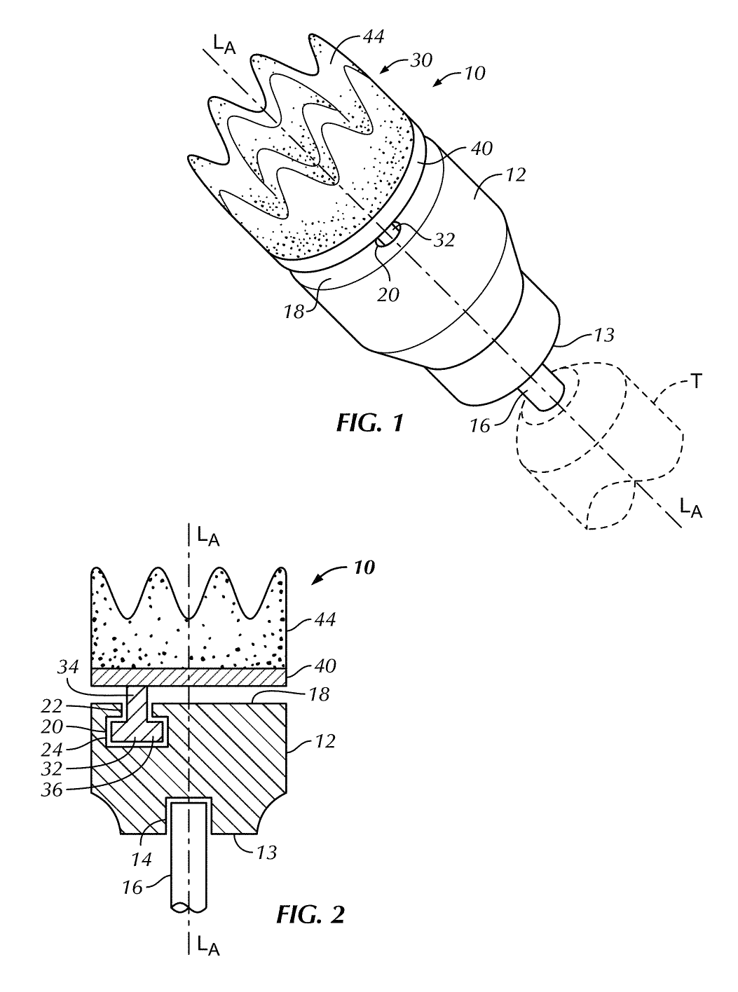

With reference next to the drawings, there is shown in FIGS. 1-3 a dental prophy orbiter 10 of a prophy angle embodying principles of the invention in a preferred form. As used herein, the terms prophy or prophy pad is intended to mean a soft pad upon to which prophy paste may be applied and which may take on many different forms. The term prophy orbiter is intended to mean the present invention which causes the prophy pad to travel in an orbital path. The term prophy angle is intended to mean the prophy orbiter in combination with an angled portion to position the prophy orbiter at an angle with respect to a dental hand piece T.

The prophy orbiter 10 includes a polymer or metallic main housing 12 having a bottom surface 13 with centrally aligned shaft channel 14 sized and shaped to fixedly receive a drive shaft 16. The drive shaft 16 is configured to be coupled to a conventional dental rotating hand piece T or to an angled portion 15 which in turn is coupled to a conventional dental rotating hand piece T utilized to polish teeth. The main housing 12 also includes a top surface 18 with an centrally offset rod channel 20. The rod channel 20 has a first portion 22 of a first select diameter and an second portion 24 of a second select diameter larger than the first select diameter.

The prophy orbiter 10 also includes a polishing head 30 coupled to the main housing 12 for free, spinning rotational movement relative to the main housing 12. The polishing head 30 includes a mounting shaft, member or rod 32 having a rod first portion or shaft 34 configured to be rotationally received within the rod channel first portion 22 and a rod second portion or head 36 configured to be rotationally received withing the rod channel second portion 24. The enlarged head 36 prevents the mounting rod 32, and thus the polishing head 30, from separating from the main housing 12. The drive shaft 16 is aligned along a longitudinal axis LA while the mounting rod 32 is centrally offset, or axially or radially offset, from the drive shaft 16 and the longitudinal axis LA along the drive shaft 16.

The polishing head 30 also includes a mounting plate 40 coupled to the mounting rod 32 oppositely from head 36. The mounting plate 40 is coupled to the mounting rod 32 at a position offset from the center of the mounting plate 40. A foam prophy pad 44 is coupled to the mounting plate 40 through an adhesive, or other attachment means. The prophy pad 44 may be made of a closed cell polyethylene material, such as a LP15 type foam, high density zote foam, or alternatively a closed cell medical grade polymer, such as a polyethylene or polyurethane. This foam may be impregnated with a cleaning agent to aid in the polishing process. The prophy pad 44 may be of any configuration, such as a flat surface or an undulating surface.

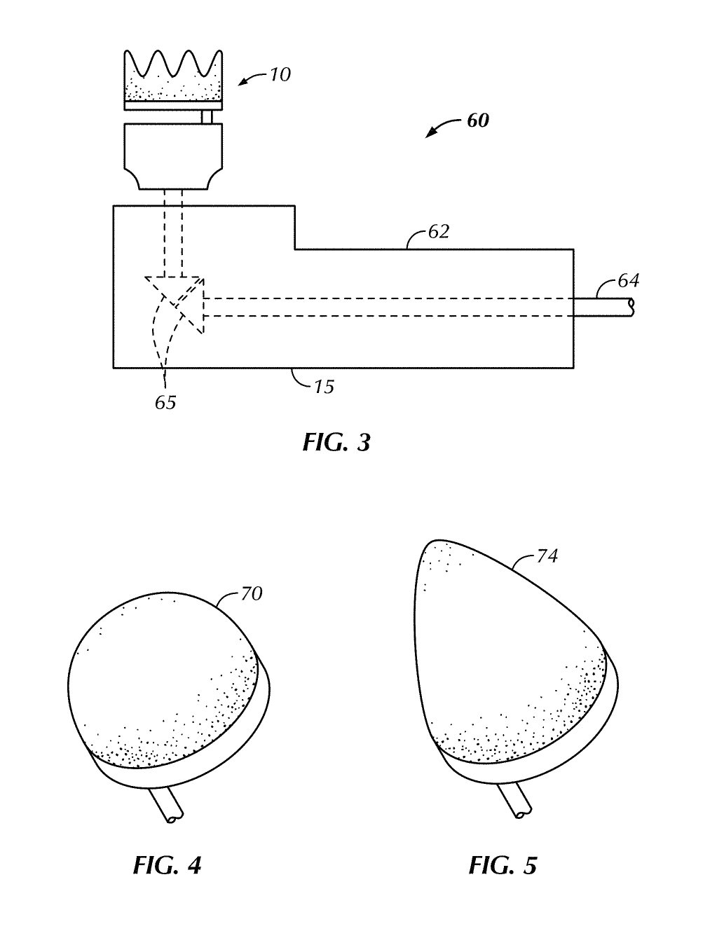

In use, the prophy orbiter 10 is coupled to a conventional rotating dental hand piece T which preferably rotates the prophy orbiter 10 at a range of 2,500 to 3,000 rpms. The rotation of the dental hand piece transfers the rotational motion to the drive shaft 16, either directly as shown in FIG. 1 or indirectly within the angled portion 15 which in turn is coupled to and rotatably drives the drive shaft 16 as shown in FIG. 3. The rotation of the dental hand piece T causes the main housing 12 to rotate at the same speed.

The rotational motion of the main housing 12 causes the offset polishing head 30 to also rotate. However, due to the offset positioning of the rod channel 20 and mounting rod 32 the polishing head 30 travels along an oblong, offset orbit or random orbit path (orbital movement). The random orbit prevents scratching of the teeth since the polishing head takes a different path upon the teeth with each rotation. Additionally, as the polishing head 30 is free moving relative to the main housing 12, should the polishing head 30 be pressed too hard against the teeth, the spinning rotation of the polishing head 30 will stop and only the smaller offset rotation created by the offset position of the mounting rod 32 will continue. This is believed to significantly reduce the chances of scratching the teeth.

With specific reference next to FIG. 3, there is shown a prophy orbiter 60 shown mounted to the angled portion 15. The prophy orbiter 10 may be used at an angle with respect to the hand piece T. As such, the drive shaft 64 may include internal gears 65 to create the transition from one direction to another.

With reference next to FIG. 4, there is shown a foam pad 70 for a prophy orbiter in another preferred form of the invention. Here, the foam pad 70 has a generally dome shaped top surface.

With reference next to FIG. 5, there is shown a foam pad 74 for a prophy orbiter in another preferred form of the invention. Here, the foam pad 74 has a generally cone shaped top surface.

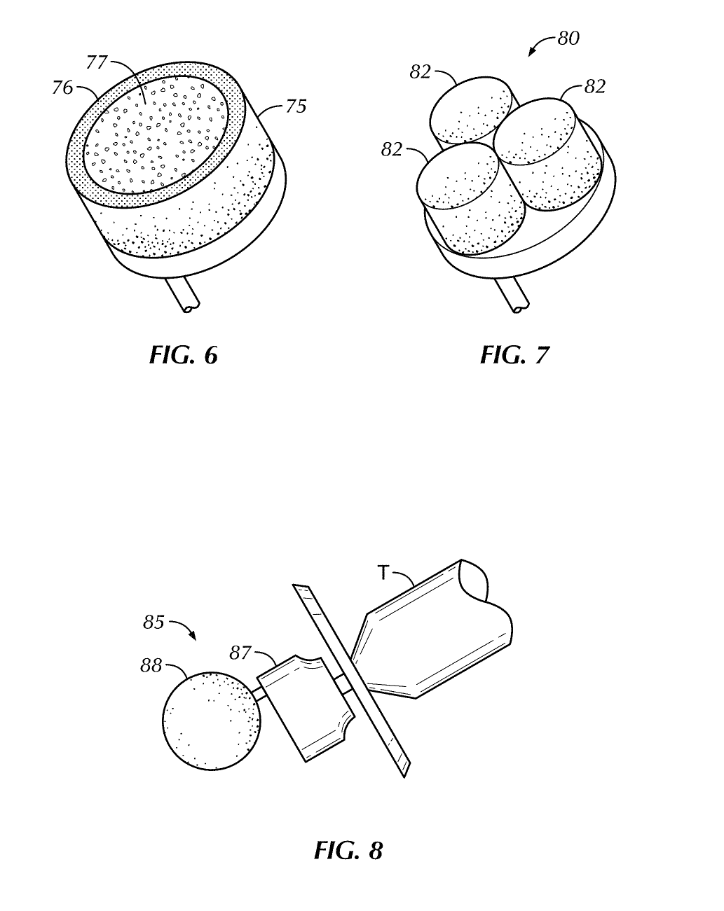

With reference next to FIG. 6, there is shown a foam pad 75 for a prophy orbiter in another preferred form of the invention. Here, the foam pad 75 has a peripheral non-absorbent layer 76 surrounding an internal, absorbent layer 77. The peripheral, non-absorbent layer is believed to limit splatter due to the polishing material migrating through the absorbent layer 77.

With reference next to FIG. 7, there is shown a foam pad 80 for a prophy orbiter in another preferred form of the invention. Here, the foam pad 80 has three generally cylindrical pads 82 to provide additional polishing surfaces.

With reference next to FIG. 8, there is shown a prophy orbiter 85 in another preferred form of the invention. Here, the prophy orbiter 85 includes a splatter plate or shield 86 positioned between the main housing 87 and the polishing head 88 which does not rotate. Also, the foam pad has a generally spherical shaped.

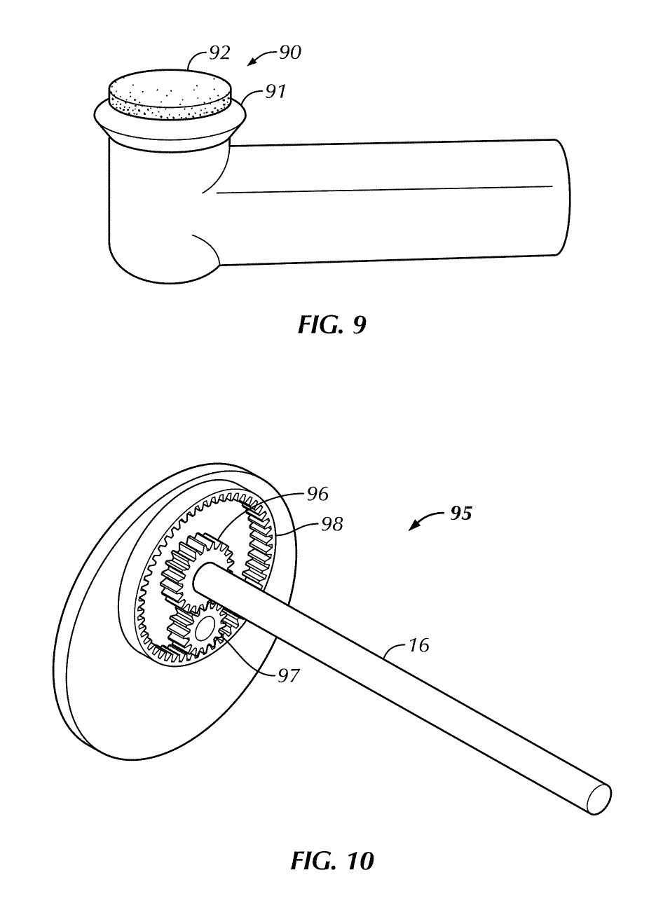

With reference next to FIG. 9, there is shown a prophy orbiter 90 in another preferred form of the invention. Here, the prophy orbiter 90 includes an interproximal ring about the foam pad 92 to create a surface to clean between two adjacent teeth.

With reference next to FIG. 10, there is shown a prophy orbiter 95 in another preferred form of the invention. Here, the prophy orbiter 95 includes a drive gear 96 coupled to the shaft 16 which drives a gear 97 coupled to the polishing head which in turn is meshed with an offset internal gear 98. The rotation of the shaft causes the direct rotation of the polishing head as an alternative to the free moving polishing head of the previous embodiments.

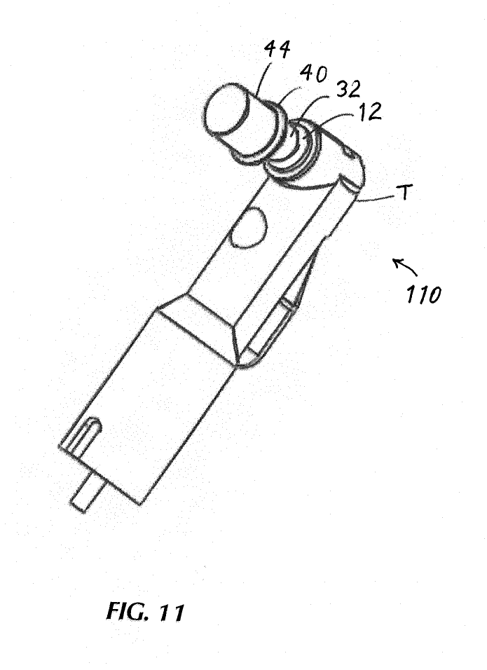

Lastly, with reference next to FIG. 11, there is a shown a prophy orbiter 100 in another preferred form of the invention. The prophy orbiter 100 includes the previously described prophy pad 44, mounting plate 40, mounting rod 32, main housing 12, and hidden from view drive shaft. As shown, the mounting rod 32 may be of different sizes, as compared to the previous views.

It should be understood that the pad may also be in other shapes, such as frusto-conical. Furthermore, the pad may include cuts, detents, bumps or the like to provide a contoured exterior surface to provide additional polishing areas on the surface of the pad.

It should be understood that the pivotal mounting of the mounting rod may be imparted upon the prophy head by simply having the rod channel 20 extend into the prophy head rather than the main housing, i.e., the rod is pivotal relative to the prophy head rather than the main housing.

It should also be understood that the drive shaft or shaft 16 may be configured to fit various hand pieces, such as a right-angled hand piece or a straight hand piece.

It should be understood that the orbital path may be induced by an offset weight upon a rotating part.

Lastly, it should be understood that the prophy orbiter may be constructed so as to be reusable, or have select portions reusable, such as the main housing.

It thus is seen that a dental prophy orbiter is now provided which restricts splatter and scratching of the teeth. And though the invention has been shown and described in its preferred form, it should be understood that additions, deletions and modifications may be made without departure from the spirit and scope of the invention as set forth in the following claims.

1. A dental prophy orbiter comprising:
a drive shaft;
a main housing coupled to said drive shaft;
a prophy head, and
a mounting rod having a first end and a second end, said mounting rod first end being coupled to said main housing in a centrally offset position, said mounting rod second end being coupled to said prophy head, said rod being pivotally coupled to either said main housing or said prophy head,
whereby rotational movement of the drive shaft causes rotational movement of the main housing which results in orbital movement of the prophy head.

2. The dental prophy orbiter of claim 1 wherein said main housing has a rod channel and wherein said mounting rod first end is pivotally mounted within said rod channel.

3. The dental prophy orbiter of claim 2 wherein said main housing rod channel has a channel first portion of a first select diameter and a channel second portion of second select diameter greater than said first select diameter, and wherein said rod first end has a rod first portion configured to pivotally reside within said channel first portion and a rod second portion configured to pivotally reside within said channel second portion.

4. The dental prophy orbiter of claim 1 wherein said prophy head includes a mounting plate and a prophy pad coupled to said mounting plate.

5. The dental prophy orbiter of claim 1 wherein said drive shaft includes a first gear, and wherein said main housing includes at least a second gear meshed with said first gear to transfer rotational movement from said drive shaft to said main housing.

6. A dental prophy orbiter comprising:
a drive shaft;
a main housing coupled to said drive shaft;
a prophy head coupled to said main housing for imparting an orbital path of travel to said prophy head upon rotation of said main housing.

7. The dental prophy orbiter of claim 6 wherein said prophy head is coupled to said main housing through a mounting rod extending between said main housing and said prophy head in an axially offset position relative to said drive shaft.

8. The dental prophy orbiter of claim 7 wherein said mounting rod has a first end and a second end, said mounting rod first end being coupled to said main housing in an axially offset position, said mounting rod second end being coupled to said prophy head, said rod being pivotally coupled to either said main housing or said prophy head.

9. The dental prophy orbiter of claim 8 wherein said main housing has a rod channel and wherein said mounting rod first end is pivotally mounted within said rod channel.

10. The dental prophy orbiter of claim 9 wherein said main housing rod channel has a channel first portion of a first select diameter and a channel second portion of second select diameter greater than said first select diameter, and wherein said rod first end has a rod first portion configured to pivotally reside within said channel first portion and a rod second portion configured to pivotally reside within said channel second portion.

11. The dental prophy orbiter of claim 6 wherein said prophy head includes a mounting plate and a prophy pad coupled to said mounting plate.

12. The dental prophy orbiter of claim 6 wherein said drive shaft includes a first gear, and wherein said main housing includes at least a second gear meshed with said first gear to transfer rotational movement from said drive shaft to said main housing.

13. A dental prophy orbiter comprising:
a drive shaft aligned along a longitudinal axis;
a main housing coupled to said drive shaft;
a prophy head coupled to said main housing at a location radially offset from said longitudinal axis,
whereby rotational movement of the drive shaft causes rotational movement of the main housing which results in orbital movement of the prophy head.

14. The dental prophy orbiter of claim 13 wherein said prophy head is coupled to said main housing through a mounting rod extending between said main housing and said prophy head in an axially offset position relative to said longitudinal axis.

15. The dental prophy orbiter of claim 14 wherein said mounting rod has a first end and a second end, said mounting rod first end being coupled to said main housing in an axially offset position relative to said longitudinal axis, said mounting rod second end being coupled to said prophy head, said rod being pivotally coupled to either said main housing or said prophy head.

16. The dental prophy orbiter of claim 15 wherein said main housing has a rod channel and wherein said mounting rod first end is pivotally mounted within said rod channel.

17. The dental prophy orbiter of claim 16 wherein said main housing rod channel has a channel first portion of a first select diameter and a channel second portion of second select diameter greater than said first select diameter, and wherein said rod first end has a rod first portion configured to pivotally reside within said channel first portion and a rod second portion configured to pivotally reside within said channel second portion.

18. The dental prophy orbiter of claim 13 wherein said prophy head includes a mounting plate and a prophy pad coupled to said mounting plate.

19. The dental prophy orbiter of claim 13 wherein said drive shaft includes a first gear, and wherein said main housing includes at least a second gear meshed with said first gear to transfer rotational movement from said drive shaft to said main housing.
